(19) United States
(12) Patent Application Publication
(10) Pub. No.: US 2010/0141162 A1
(43) Pub. Date: Jun. 10, 2010

(54) LED DRIVER CIRCUIT WITH SEQUENTIAL LED LIGHTING CONTROL

(76) Inventors: Kouji Matsumoto, Sanjo (JP); Kenichi Takmatsu, Tsubame (JP); Tsukasa Ogura, Niigata (JP); Masashi Kitima, Niigata (JP); Takashi Aida, Sanjo (JP)

Correspondence Address: WADDEY & PATTERSON, P.C., 1600 DIVISION STREET, SUITE 500, NASHVILLE, TN, 37203, US

(21) Appl. No.: 12/630,319

(22) Filed: Dec. 3, 2009

(30) Foreign Application Priority Data
Dec. 3, 2008 (JP) 2008-308390

(51) Int. Cl. H05B 37/02

(52) U.S. Cl. 315/186

(57) ABSTRACT

An LED driver circuit powers a plurality of LED arrays coupled in parallel, each LED array having one or more LEDs coupled in series. A power converter converts an input signal from a power source into an output signal across the LED arrays. A switching element is coupled in series with each of the LED arrays and alternates between first and second switch states in response to lighting control signals. A control circuit generates the lighting control signals and supplies them to the switching elements to sequentially operate one or more of the switching elements in the first switch state during each of a plurality of predetermined time periods in a light emitting state for the LED driver circuit.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: Japan Patent Application No. 2008-308390, Filed Dec. 3, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to an LED driver circuit for powering a plurality of LEDs. More particularly, the present invention relates to an LED driver circuit configured to sequentially power LED arrays during a light emitting state and reduce operational stresses thereby.

Lighting fixtures using a light emitting diode (referred to as an LED hereinafter) as a light source are generally configured with a plurality of LEDs because each individual LED has a relatively small light output compared to, for example, a gas discharge lamp. LEDs manufactured according to the same specifications may generally be used as a light source configured with a plurality of LED arrays connected in parallel, each array consisting of a plurality of LEDs connected in series with each other.

An example of a conventional LED lighting fixture as known in the art uses an LED driver circuit for driving a plurality of LEDs connected in parallel by a constant current to realize a constant light output regardless of the environment or application. In this case, each of the LED arrays is connected in series to a switching element such as a transistor, and the respective switching elements are turned on/off simultaneously by one lighting control signal supplied from a control circuit. The entire system of LEDs is therefore turned on and/or turned off simultaneously during a state in which the LEDs are provided with a current to produce a light output (herein referred to as a “light emitting state”).

The life of LEDs has been extended greatly by developments in semiconductor design techniques, but recent demands require even further extended life for lighting fixtures using LEDs. This is a problem for the above-referenced conventional lighting fixture, in that a current simultaneously flowing into the entire system of LEDs during a light emitting state causes a stress constantly applied to each of the LEDs that negatively influences the lifespan thereof.

### BRIEF SUMMARY OF THE INVENTION

An LED driver circuit in accordance with the present invention is provided for extending the life of an LED by reducing operational stresses applied to the LED during a light emitting state in which current is supplied to the LED to produce a light output.

The LED driver circuit of the present invention is configured for turning on and turning off a plurality of LED arrays connected in parallel, each LED array constituting a plurality of LEDs connected in series. The driver circuit includes a switching element which is connected in series to each of the LED arrays and is turned on/off by a lighting control signal. A control circuit is provided for generating the lighting control signal supplied to the switching element, wherein the control circuit generates the lighting control signal to sequentially turn off at least one of the LED arrays at each of a plurality of predetermined time intervals in a light emitting state of the LED arrays. This configuration allows electrical stress applied to the LEDs to be reduced and provides for an extended service life.

In another aspect of the present invention, a voltage detection circuit is provided for detecting a voltage output from the converter and provided across the LED arrays in the LED driver circuit, wherein the control circuit generates the lighting control signal based on a voltage detected by the voltage detection circuit. This configuration allows at least one of the LED arrays to be turned off sequentially at each of a plurality of predetermined time intervals in a light emitting state of the LED arrays, and provides a constant light output by causing a constant current to flow into the LED arrays, whereby electrical stress applied to the LEDs can be reduced to realize an extended service life.

In another aspect, the present invention may include a current detection circuit for detecting a current flowing into the entire system of LED arrays in the LED driver circuit, wherein the control circuit generates the lighting control signal based on a current detected by the current detection circuit. This configuration further allows at least one of the LED arrays to be turned off sequentially at every predetermined time in the light emitting state of the LED arrays and provides a constant light output, whereby a stress applied to the LEDs can be reduced to realize an extended service life.

In another aspect, the present invention includes a pulse width modulation (PWM) circuit arranged in the control circuit of the LED driver circuit, and the lighting control signal is generated based on a duty cycle set in accordance with the detected voltage and/or current.

This configuration further allows at least one of the LED arrays to be turned off sequentially at every predetermined time in the light emitting state of the LED arrays and provides constant light output, whereby a stress applied to an LED can be reduced to realize an extended service life.

In another aspect, the present invention also includes a resistor connected in series with each of the LED arrays in the LED driver circuit. This configuration makes it possible to prevent excessive current from flowing into the LED arrays, whereby the electrical stress applied to the LED is reduced to realize an extended service life.

In another aspect, the present invention connects a Zener diode in parallel with each LED, each Zener diode having a threshold voltage that is larger than a forward voltage in the parallel-connected LED and further having polarity reversed with respect to the LED.

In this configuration, a current is made to flow only in the serially connected LEDs in a normal LED state. Even if any of the plurality of the serially connected LEDs are disconnected due to a failure or other causes, a current is made to flow through a bypass circuit via a Zener diode connected in parallel with a disconnected LED. Accordingly, it is made possible to prevent the LED arrays from being extinguished entirely in response to a mere failure in one LED out of the entire system.

### BRIEF DESCRIPTION OF THE SEVERAL VIEWS OF THE DRAWINGS

FIG. 1 is a circuit diagram showing an LED driver circuit according to an embodiment of the present invention.

FIG. 2 is a timing chart showing one example of lighting control signals in the LED driver circuit according to the embodiment of FIG. 1.

FIG. 3 is a timing chart showing another example of the lighting control signals in the LED driver circuit according to the embodiment of FIG. 1.

FIG. 4 is a timing chart showing a PWM control provided for lighting control signals in the LED driver circuit according to the embodiment of FIG. 1.

FIG. 5 is a circuit diagram showing an LED driver circuit according to another embodiment of the present invention.

FIG. 6 is a circuit diagram showing an LED driver circuit according to still another embodiment of the present invention.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The term “coupled” means at least either a direct electrical connection between the connected items or an indirect connection through one or more passive or active intermediary devices. The term “circuit” means at least either a single component or a multiplicity of components, either active and/or passive, that are coupled together to provide a desired function. The term “signal” means at least one current, voltage, charge, temperature, data or other signal. Where either a field effect transistor (FET) or a bipolar junction transistor (BJT) may be employed as an embodiment of a transistor, the scope of the terms “gate,” “drain,” and “source” includes “base,” “collector,” and “emitter,” respectively, and vice-versa. The term “light emitting state” may be with reference to the LED driver circuit generally or various components of the LED driver circuit, and may include any state during which an output signal is provided to turn on/ignite one or more LEDs for the purpose of producing a desired light output.

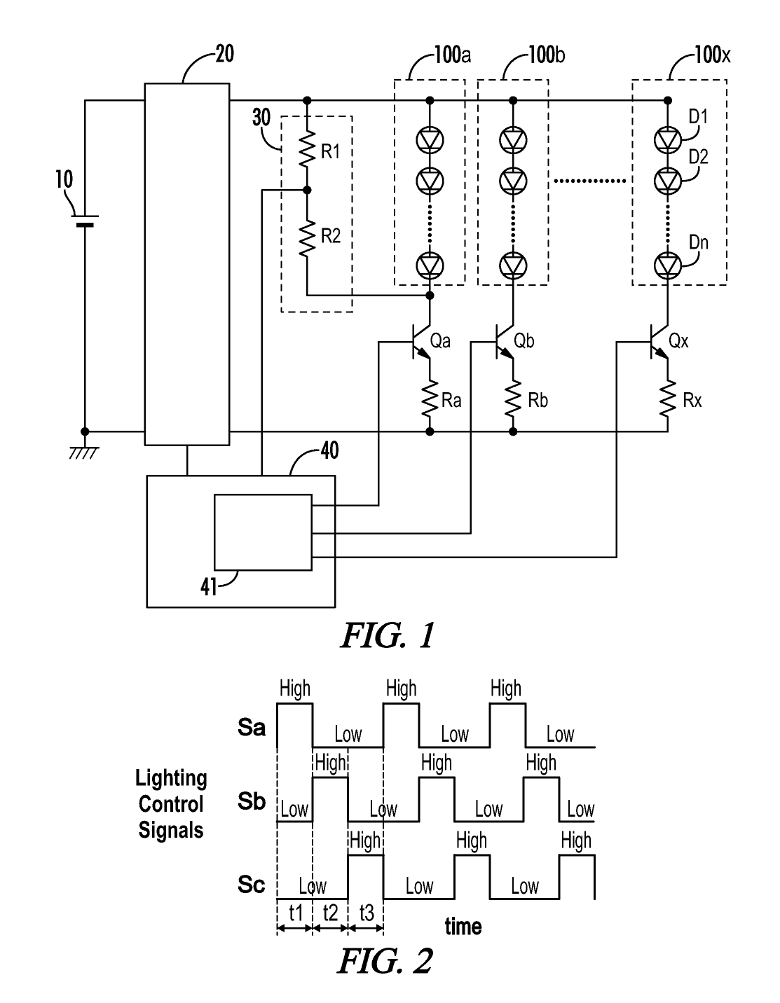

An LED driver circuit in accordance with the present invention may now be described herein with reference to FIGS. 1 6. Where the various figures may describe embodiments sharing various common elements and features with other embodiments, similar elements and features are given the same reference numerals and redundant description thereof may be omitted below.

In various embodiments, an LED driver circuit is capable of realizing an extended service life for one or more LEDs powered by the driver circuit, by reducing electrical stresses applied thereto. An LED driver circuit according to various embodiments as described herein may be used with, as but one example, an LED lighting fixture in a vehicle such as an automobile.

Referring now to an embodiment of the present invention as shown in FIG. 1, an LED driver circuit is configured to have a DC power source 10 such as a battery, a DC-DC converter 20, a voltage detection circuit 30 and a control circuit 40.

The DC-DC converter 20 is configured to have a semiconductor element and a transformer (not shown) so as to convert a DC voltage supplied from the DC power source 10 into a predetermined voltage output signal which is supplied to turn on LED arrays 100a to 100x, the arrays to be further described later.

The voltage detection circuit 30 includes resistors R1 and R2 connected in series between a positive voltage side of the DC-DC converter 20 and a collector of a switching element such as for example an NPN transistor Qa. An output voltage provided to the LED arrays 100a to 100x is divided and detected by the resistors R1 and R2. A detected voltage is fed back to the control circuit 40 so as to control the voltage output from the DC-DC converter 20.

The control circuit 40 has a switch control circuit 41 which outputs a lighting control signal for adjusting the switch states for each of a plurality of switching elements such as for example NPN transistors Qa to Qx to be described later, the control signal having a predetermined period and duty cycle or ratio, and integrally controlling each part of the LED driver circuit while controlling the LED arrays 100a to 100x to be turned on and turned off.

In a first switch state, the switching elements may be referred to herein as ON, wherein power is supplied across the LED array. This first switch state may further be referred to as “turning on” the LED array. In a second switch state, the switching elements may be referred to herein as OFF, wherein power is not supplied across the LED array. This second switch state may further be referred to as “turning off” the LED array.

Each of the LED arrays 100a to 100x has a plurality of LEDs D1 to Dn connected in series in a forward direction, and are connected in parallel between a positive voltage terminal and a negative (ground) terminal of the DC-DC converter 20.

Also connected in series with the LED arrays 100a to 100x are NPN transistors Qa to Qx and resistors Ra to Rx, respectively, with the transistor-resistor series combinations being coupled between the LED arrays and the ground terminal of the DC-DC converter 20.

Each collector of the NPN transistors Qa to Qx is connected to a cathode of the LEDs D1 to Dn belonging to each of the LED arrays 100a to 100x, and an emitter of the NPN transistors Qa to Qx is connected to each of the resistors Ra to Rx. A base of each of the NPN transistors Qa to Qx is connected to the switch control circuit 41 to receive a lighting control signal.

The resistors Ra to Rx define a current flowing into the LED arrays 100a to 100x and function to turn on the LEDs D1 to Dn with a predetermined light output.

Operation of an LED driver circuit according to embodiments of the present invention configured as described above and as shown in FIG. 1 may be explained in greater detail.

The switch control circuit 41 inputs a periodic reference signal having a fixed period and generates a plurality of lighting control signals each having a different phase for output to each base of the NEP transistors Qa to Qx.

Referring to FIG. 2, an example is shown of the lighting control signals generated by the switch control circuit 41. Sa to Sc refer to the lighting control signals supplied to the respective bases of the transistors Qa to Qc.

As shown in FIG. 2, the lighting control signal Sa is high and the lighting control signals Sb and Sc are low in a period t1. Therefore, the transistor Qa is turned on so as to cause a current to flow into the LEDs D1 to Dn in the LED array 100a and turn on the LEDs in this array. At this time, the transistors Qb and Qc are turned off, wherein the LEDs D1 to Dn in each of the LED arrays 100b and 100c are not lit during the period t1.

In a subsequent period t2, only the lighting control signal Sb is high and the other signals are low, wherein the transistor Qb is turned on to light only the LEDs in the LED array 100b. Similarly, in a period t3, the lighting control signal Sc is high to ignite the LEDs in the LED array 100c.

The lighting control signals with shifted phases are thus supplied to the respective bases of the transistors Qa to Qx, whereby the corresponding LED arrays 100a to 100x are turned on sequentially. Electrical stress applied to the LEDs D1 to Dn in each of the LED arrays 100a to 100x is therefore reduced to realize an extended service life of the LEDs.

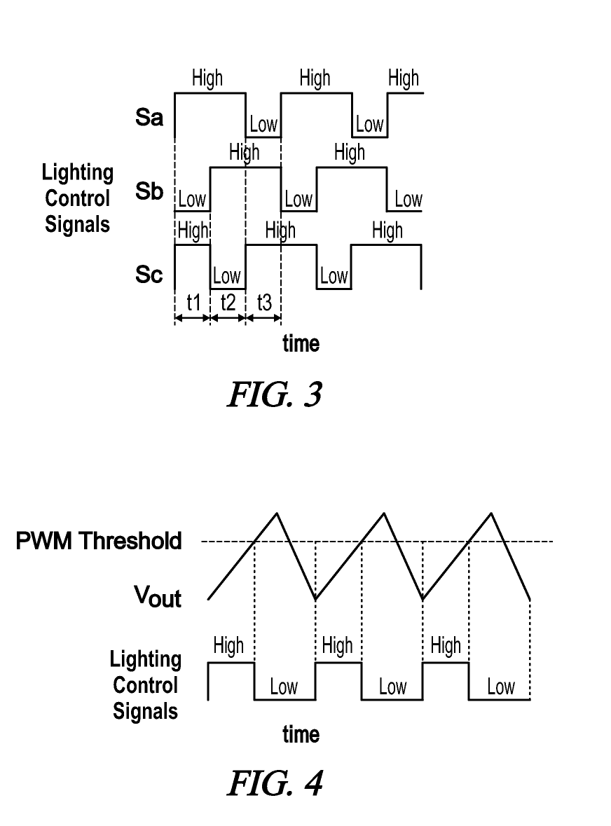

Referring now to FIG. 3, another example may be demonstrated of the lighting control signals generated by the switch control circuit 41.

In FIG. 3, the lighting controls signals Sa and Sc are high and the lighting control signal Sb is low in a period t1. The transistors Qa and Qc are therefore turned on so as to cause a current to flow into the LED arrays 100a and 100c, whereby lighting is achieved in the LEDs D1 to Dn in the respective LED arrays. At this time, the transistor Qb is turned off with no lighting observed in the LEDs D1 to Dn in the LED array 100b.

In a period t2, the lighting control signals Sa and Sb are high and the lighting control signal Sc is low, wherein the transistors Qa and Qb are turned on to realize lighting in the LED arrays 100a and 100b. Similarly, in a period t3, the lighting control signals Sb and Sc are high to realize lighting in the LED arrays 100b and 100c.

The lighting control signals shown in FIG. 3 thus allow simultaneous lighting in two of the LED arrays in each given time period. Therefore, electrical stress applied to the LEDs D1 to Dn in each of the LED arrays 100a to 100x is reduced to realize an extended service life. Note that the LED arrays disposed adjacent to each other are turned on and/or turned off simultaneously in the present embodiment, but operation is not so limited and alternative examples are contemplated within the scope of the present invention. For example, two of the LED arrays arranged within a predetermined distance may also be turned on and/or turned off simultaneously. Moreover, the number of LED arrays to be turned on and/or turned off simultaneously is not limited to one or two and may also be three or more.

As explained above, an LED driver circuit configured according to the embodiment shown in FIG. 1 may switch the transistors connected to the plurality of the LED arrays each containing the plurality of serially connected LEDs by the lighting control signals with mutually shifted phases so as to turn on the LED arrays sequentially, whereby a stress applied to the LEDs can be reduced to realize an extended service life.

Various embodiments so configured may exemplify a method to maintain a constant current flowing into LED arrays by controlling a voltage output from the DC-DC converter 20 based on a forward voltage in the LED arrays detected by the voltage detection circuit 30 as shown in FIG. 1.

In the voltage detection circuit 30 shown in FIG. 1, the forward voltage in the LED arrays 100a to 100x is detected by dividing a generated voltage by a current flowing into the resistors R1 and R2 which are connected between a positive voltage terminal of the DC-DC converter 20 and a collector of the NPN transistor Qa, and input to a comparator (not shown) in the control circuit 40 to calculate a difference relative to a reference voltage so as to output to the DC-DC converter 20.

The DC-DC converter 20 may control a PWM circuit (not shown) based on an output from the comparator so as to output a DC voltage to the LED arrays 100a to 100x. A current flowing into the LED arrays is therefore maintained to be constant and a predetermined light output can be obtained.

A forward voltage in the LED arrays detected by the voltage detection circuit 30 is also used for setting a duty cycle or ratio of the lighting control signals supplied to the transistors Qa to Qx.

Referring now to FIG. 4, an example is shown of a method for maintaining a constant lighting output in the LED arrays by setting a duty cycle of the lighting control signals through a PWM control based on a forward voltage in the LED arrays detected by the voltage detection circuit 30 as shown in FIG. 1.

As shown in FIG. 4, a PWM threshold voltage is indicated with respect to a sawtooth waveform for the forward voltage in the LED arrays as detected by the voltage detection circuit 30. In an embodiment, the lighting control signals may be switched from high to low as the sawtooth waveform crosses the PWM threshold. A duty cycle is therefore set to generate the lighting control signals supplied to the respective bases of the NPN transistors Qa to Qx in accordance with the PWM threshold crossings.

The lighting control signals to be generated are output from the switch control circuit 41 to the respective bases of the transistors Qa to Qx. Therefore, constant lighting power is maintained in the LED arrays 100a to 100x and a predetermined light output can be obtained.

Note that the present embodiment uses a forward voltage in the LED arrays detected by the voltage detection circuit 30 as a basis to control a voltage output from the DC-DC converter 20 and to set a duty cycle or ratio of the lighting controls signals, but may also, for example, detect a current flowing into the LED arrays 100a to 100x to perform a similar control and setting based on a detected current.

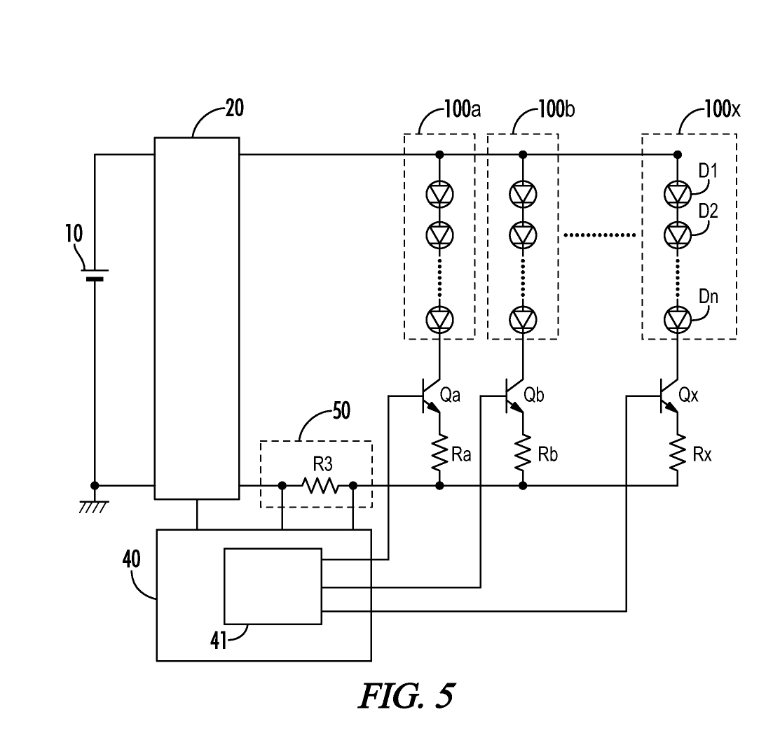

Referring now to FIG. 5, in another embodiment of the present invention an LED driver circuit is configured to have a current detection circuit 50 in place of the voltage detection circuit 30 as shown in FIG. 1.

The current detection circuit 50, which may include a resistor R3 coupled between the LED arrays 100a to 100x and the ground terminal of the DC-DC converter 20, inputs a voltage generated across the resistor R3 by a current flowing into the LED arrays 100a to 100x to the control circuit 40.

The voltage input to the control circuit 40 is used to calculate a difference relative to a reference voltage by the comparator so as to control a voltage output from the DC-DC converter 20 and to set a duty ratio of lighting control signals. Therefore, a current flowing into the LED arrays is maintained to be constant and a predetermined light output can be obtained.

As explained above, the LED driver circuit according to various such embodiments of the present invention detects a forward voltage in the LED arrays and/or a current flowing in the LED arrays, and controls a voltage output from the DC-DC converter 20 based on a detected voltage and/or current, whereby the current flowing into the LED arrays is maintained to be constant and the predetermined light output can be obtained.

A duty ratio can also be set by switching a PWM threshold based on a detected forward voltage in the LED arrays and/or a detected current flowing in the entire system of LED arrays, and the lighting control signals supplied to the transistors which are connected to the respective LED arrays are generated based on the set duty ratio, whereby the current flowing into the LED arrays is maintained to be constant and the predetermined light output can be obtained.

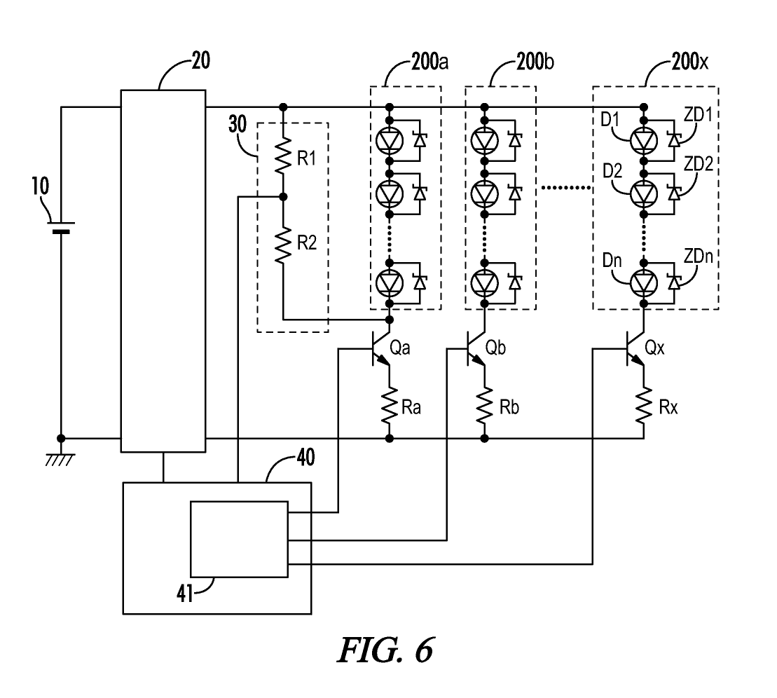

Referring now to FIG. 6, in another embodiment of the present invention an LED driver circuit is configured to have LED arrays 200a to 200x in place of the LED arrays 100a to 100x as shown in FIG. 1. The remaining configuration is the same as that of the first embodiment, and explanation thereof is omitted by providing the same reference numbers.

LEDs D1 to Dn in each of the LED arrays 200a to 200x are connected in parallel with Zener diodes ZD1 to ZDn respectively, with each polarity reversed. Here, a breakdown voltage Vc of the Zener diodes ZD1 to ZDn is set to be higher than a forward voltage Vf in the LEDs D1 to Dn.

Such a configuration realizes Vf which is smaller than Vc if the entire array of LEDs D1 to Dn are in a normal state, wherein no current is made to flow in the Zener diodes ZD1 to ZDn connected in parallel therewith, and it is only the LEDs D1 to Dn in which a current is made to flow.

However, if a failure occurs in any one of the LEDs or, for example, in the LED D1 in any of the LED arrays due to disconnection or other causes, a forward voltage is raised to make Vf larger than Vc, followed by causing a current to flow through an alternate path via the Zener diode ZD1 as a result. However, the remaining normal LEDs D2 to Dn have Vf which is smaller than Vc, so that a current is made to flow therein without bypassing via the associated Zener diodes ZD2 to ZDn.

It is therefore possible to prevent an entire array of LEDs from being turned off merely because any one of the LEDs D1 to Dn has a failure in the LED arrays 200a to 200x, each of which contains the LEDs D1 to Dn connected in series from each other.

Note that the LED arrays 200a to 200x in the embodiment shown are controlled to be turned on sequentially by switching the transistors connected to the LED arrays by the lighting control signals with mutually shifted phases in the same manner with the LED arrays 100a to 100x in the first embodiment, whereby electrical stress applied to the LEDs can be reduced.

As explained above, an LED driver circuit according to various embodiments of the present invention as shown connects the Zener diodes, having a breakdown voltage higher than a forward voltage in the LEDs, in parallel with the plurality of the LEDs in each of the LED arrays by setting each polarity reversed, thereby making it possible to prevent the LEDs from being turned off entirely in the case of having a failure in any of the plurality of the LEDs.

Thus, although there have been described particular embodiments of the present invention of a new and useful LED Driver Circuit with Sequential LED Lighting Control, it is not intended that such references be construed as limitations upon the scope of this invention except as set forth in the following claims.

What is claimed is:

1. An LED driver circuit for powering a plurality of light emitting diode (LED) arrays, each LED array comprising one or more LEDs coupled in series, the LED driver circuit comprising:
a power converter having positive and negative output terminal and configured to convert an input signal from a power source into an output signal, and wherein the LED arrays are coupled in parallel across the positive output terminal of the converter and the negative output terminal of the converter;
a plurality of switching elements, each of the switching elements coupled in series with one of the LED arrays, the switching elements configured to alternate between first and second switch states in response to lighting control signals;
a control circuit configured to generate the lighting control signals and supply the signals to the switching elements; and wherein
the control circuit supplies lighting control signals effective to sequentially operate one or more of the switching elements in the first switch state during each of a plurality of predetermined time periods in a light emitting state for the LED driver circuit.

2. The LED driver circuit of claim 1, wherein the switching elements are sequentially operated one at a time in the first switch state, wherein a current is provided across the associated LED array.

3. The LED driver circuit of claim 1, wherein two or more switching elements are sequentially operated in the first switch state, wherein a current is provided across the associated LED arrays.

4. The LED driver circuit of claim 3, wherein the two or more switching elements operated in the first switch state during any given predetermined time period are located in non-adjacent LED arrays.

5. The LED driver circuit of claim 4, wherein the two or more switching elements operated in the first switch state during any given predetermined time period are located within a predetermined number LED arrays apart from each other.

6. The LED driver circuit of claim 1, further comprising
a voltage detection circuit coupled in the driver circuit for detecting a forward voltage in the LED array; and
wherein the control circuit generates the lighting control signals based on a voltage detected by the voltage detection circuit.

7. The LED driver circuit of claim 6, wherein the control circuit further comprises a pulse width modulation (PWM) circuit, and wherein the control circuit is configured to generate the lighting control signals based on a PWM duty ratio set in accordance with the detected voltage.

8. The LED driver circuit of claim 7, the voltage detection circuit further comprising a resistive network coupled across the one or more LEDs in a first LED array.

9. The LED driver circuit of claim 1, comprising
a current detection circuit coupled in the driver circuit for detecting a current flowing through the plurality of LED arrays; and wherein
the control circuit generates the lighting control signals based on the current detected by the current detection circuit.

10. The LED driver circuit of claim 9, wherein the control circuit further comprises a pulse width modulation (PWM) circuit, and wherein the control circuit is configured to generate the lighting control signals based on a PWM duty ratio set in accordance with the detected current.

11. The LED driver circuit of claim 10, the current detection circuit further comprising a resistor coupled between the negative output terminal of the power converter and an LED array, and wherein the current detection circuit is configured to provide a detected current to the control circuit based on the current provided across the LED array.

12. The LED driver circuit of claim 1, wherein a resistor is connected in series with one or more of the plurality of LED arrays.

13. The LED driver circuit of claim 1, further comprising a Zener diode coupled in parallel with one or more LEDs and having a reverse polarity with respect to each associated LED, the one or more Zener diodes having a breakdown voltage larger than a forward voltage across the associated LED.

14. A system for powering light-emitting diodes (LEDs), the system comprising:
a plurality of LED arrays coupled in parallel with each other, each LED array comprising one or more LEDs coupled in series;
a switching element coupled in series with each of the LED arrays, the switching elements configured to change switch states in response to lighting control signals;
a Zener diode coupled in parallel with each of the one or more LEDs and having a reversed polarity with respect to each associated LED, the one or more Zener diodes further having a breakdown voltage larger than a forward voltage across the associated LED during normal operation; and
a control circuit configured to generate the lighting control signals and supply the signals to the switching elements, wherein the control circuit further comprises a pulse width modulation (PWM) circuit configured to generate the lighting control signals based on a PWM duty ratio set in accordance with a desired light output from the LED arrays.

15. The system of claim 14, wherein the control circuit supplies lighting control signals effective to sequentially operate one or more of the switching elements in a first switch state during each of a plurality of predetermined time periods in a light emitting state for the system, wherein a current is provided across the associated LED arrays.

16. The system of claim 15, wherein the control circuit supplies lighting control signals to sequentially operate the switching elements one at a time in the first switch state, wherein a current is provided across the associated LED array.

17. The system of claim 15, wherein two or more switching elements are sequentially operated in the first switch state, wherein a current is provided across the associated LED arrays.

18. The system of claim 17, wherein the two or more switching elements operated in the first switch state during any given predetermined time period are located in non-adjacent LED arrays.

19. A method of powering a plurality of parallel-coupled LED arrays in an LED lighting fixture, each LED array coupled in series with a switching element, the method comprising:
(a) providing a power converter configured to output a signal across the LED arrays;
(b) detecting the output signal across one or more of the LED arrays during a light-emitting state of the LED lighting fixture; and
(c) providing lighting control signals to sequentially operate one or more of the switching elements in a first switch state in a plurality of predetermined time periods, wherein a duty ratio for the lighting control signals is set in accordance with the detected output signal.

20. The method of claim 19, wherein the duty ratio for the lighting control signals is selected to adjust the switching elements from the first switching state to a second switching state upon the detected output signal crossing a predetermined threshold value.
